(19) United States
(12) Patent Application Publication
(10) Pub. No.: US 2018/0307886 A1
(43) Pub. Date: Oct. 25, 2018

(54) TOUCHLESS FINGERPRINT PAYMENT SYSTEM

(71) Applicant: Harsh PUJARA, Toronto (CA)

(72) Inventor: Harsh PUJARA, Toronto (CA)

(21) Appl. No.: 15/491,652

(22) Filed: Apr. 19, 2017

(51) Int. Cl. G06K 9/00

(52) U.S. Cl. CPC G06K 9/0004; G06K 9/00033

(57) ABSTRACT

The present invention is a touchless biometric payment system comprises of a touchless fingerprint apparatus to capture a fingerprint image comprising of a finger-support to secure a finger in a distance above an image capturing device, wherein the finger-support having a finger-receiving area to keep the finger in the distance from the image capture device; wherein the image capture device has a circular path which at least one camera lens is hovering around the finger to capture a 3D image; wherein the image capture device moves up and down within a tubular canal; a payment processing system to retrieve and compare the fingerprint image with a database; and a computer-implemented program to manage and process the payment.

### FIELD OF THE INVENTION

The present invention relates generally to payment systems and specifically to a biometric payment system.

### BACKGROUND OF THE INVENTION

Plastic or credit cards are commonly used for money transactions instead of carrying cash. At the same time, making unauthorized transaction has become a serious problem, costing the consumers millions of dollars annually. Therefore, other methods of transaction to minimize unauthorized transactions are becoming more desirable.

One method of safeguarding against unauthorized users is the implementation of biometric instruments. A biometric transaction system uses biometric authentication to identify a user. One example of it is a fingerprint payment, based on finger scanning. In this method, the customer scans his index finger using a point of sale (POS) finger scan reader. The finger scan reader encrypts multiple point-to-point measurements of the fingerprint and stores the customer's biometric data and banking information in a centralized database. Fingerprints are unique to each user, and their use eliminates remembering any password.

The currently used fingerprint systems connect user's pre-collected and saved fingerprint to a particular account for payment. During a transaction, the user simply puts his/her finger on the payment terminal scanner so that his/her fingerprint can be scanned. The information is then sent to a payment server. The server verifies the fingerprint against a pre-collected fingerprint, and completes the payment once it authenticates the newly scanned fingerprint.

Although the technologies for fingerprint collection and recognition are quite mature, a simple method of using fingerprint for payment is still potentially unsafe. Such devices can suffer from interference from latent fingerprints left on the scanner platen, high failure to acquire rates due to variations in skin condition (dry, moist, oily, or worn), and variation in prints due to varying amounts of pressure during the scan.

In some conventional systems for acquiring fingerprint images movement of the finger may cause distortion of the examined finger while capturing the fingerprint image.

To overcome the disadvantages of the existing fingerprint-payment technologies, the present invention provides a safer method of doing fingerprint payment.

### SUMMARY OF THE INVENTION

The system disclosed herein is a touchless fingerprint payment system (SnapPay) comprises a touchless fingerprint image capturing apparatus and a touchless fingerprint payment application.

The system comprises an apparatus that holds the printing finger securely and still in a distance above the image capturing device of the system to prevent of any distortion of the examined finger and overcome the disadvantage of the movement of the finger while capturing an image of the finger. The system further prevents of reuse and duplication from the fingerprints remaining on the surface of the scanner by others and eliminates fraudulent payment transactions. Touchless fingerprint payment system provides a higher quality fingerprint images, faster capture times and unattended fingerprint collection and improving hygiene. In addition, the present invention speeds up access control and identity processing in high traffic areas, such as POS terminals.

The system further comprises of a payment mobile application (SnapPay application) that the customer install on their mobile phone to initiate registration of their fingerprint. Once they download the application on their mobile phone, they can register themselves by using their email address. The SnapPay application allows customers to store their cards (credit/debit card, gift card and bank account) information on the application. After storing their cards into the SnapPay application; customers will have to assign each card with their fingerprints, (one card-one finger, and up to 10 cards can be stored).

Customer can connect their fingerprints to each card. The SnapPay application enables a connection between the customers fingerprint characteristics with the financial account information of the customer. The information is saved in a database associated with the payment system. The customer will have to register only once in the SnapPay application. After the registration process is completed, customer can go to any SnapPay terminal without carrying any payment device to make a payment. SnapPay terminals can be further enhanced in a way that it can detect finger prints just by scanning the fingers without the need of taking a picture or touching the scanner screen.

Furthermore, each fingerprint may correspond to special account of the customer, for example, the index finger may correspond to the debit card of the customer while the middle finger may correspond to master card of the customer, or thumb may correspond to visa card. They can use multiple fingerprints for multiple cards.

The payment terminal of the system (SnapPay terminal) further comprises of an apparatus for a touchless capture of a fingerprint image. The apparatus has a finger support that includes a finger receiving area sized and shaped to receive a finger. The finger receiving area is a hollow aperture, which is shaped and sized so that it permits only the fingerprint-bearing distal portion of a user's finger to struck out and stand in a distance above the image capture device. The finger receiving area further holds the finger while preventing of any movement of the finger that can cause distortion in fingerprint image. The apparatus can be used by people with no concentration, shaky hands due to various diseases for example Parkinson or even elderlies.

The SnapPay terminal further comprises of an image capture device mounted in front of the finger support. The image capture device is operable to capture a fingerprint image of the finger in a touchless manner.

When the customer approaches the SnapPay terminal to make a payment for a product or a service, the SnapPay terminal camera captures an image of a finger of the customer and processes it as payment device, which is pre-registered in the system and is connected to an account. The payment system collects, and stores payment transactions and analyzes the image with the fingerprints that are registered with the account and takes a payment out of the corresponding account. The customer is not required to touch any scanner or camera screen. The biometric characteristic of the fingerprint is sent to a biometric processor in the system for comparison with the stored fingerprint characteristic through a cryptographic algorithm. If the fingerprint image matches a pre-registered and stored fingerprint in database, the merchant authorizes customers fingerprint and makes a payment.

The customer just holds his/her finger in front of the camera and the system takes out the payment. Since the fingerprints of the customer is taken by the camera without any press or touch of the finger on the surface of the finger scanner, no trace of the fingerprint of the user will remain on the scanner. Furthermore, the customer does not have to carry any payment instrument, such as credit, debit or gift cards, or even his/her mobile phone to make a payment.

The system comprises of a database which stores all the details of customer's credit/debit/gift cards and his/her fingerprints. The fingerprints of the customer are scanned and locked to each card. The system will analyze the data and check that the fingerprint is registered/locked with correspondent card and will take a payment out of that automatically. The system allows the customers to check their account on the application of the mobile phone.

It is an object of the present invention to provide a touchless fingerprint payment system that allows anyone to make a payment through his or her fingerprints by just holding a finger above an apparatus.

It is another object of the present invention to provide a fast and an accurate touchless fingerprint payment system.

Another objective of the present invention is to provide a system to hold the finger of the user in a manner, without any movement in a distance above the camera.

It is another object of the present invention to provide a system, which can be used by people with no concentration, shaky, hands due to various diseases for example Parkinson or even elderlies.

It is another object of the present invention to provide a most secured payment for the customers by using fingerprints.

It is another object of the present invention to reduce the usage of paper receipts and plastic cards.

It is another object of the present invention to provide a convenient payment method, which do not need any device or cash to carry by the user.

It is further another object of the present invention to provide a touchless payment system to prevent of duplication of the fingerprint of the user remaining on the screen.

It is another object of the present invention to provide the most hygiene payment system, which do not request any touch of cash, payment cards or finger print scanner screens.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 is a network environment illustrating interaction between mobile device of a user and a POS terminal according to the present invention;

FIG. 2A illustrates a perspective view of touchless fingerprint imaging apparatus according to the present invention;

FIG. 2B illustrates a perspective view of touchless fingerprint imaging apparatus according to the present invention;

FIG. 3 illustrates a perspective view of touchless fingerprint imaging apparatus according to the present invention;

FIG. 4 is flowchart illustrating a method of registering a customer's fingerprint as a payment instrument according to the present invention;

FIG. 5 is a block diagram of a mobile device according to the present invention;

FIG. 6 is a flow chart illustrating a communication network between the mobile device and SnapPay terminal according to the present invention;

FIG. 7 is a flowchart illustrating a method of processing a payment using a fingerprint image; and

FIG. 8 is a block diagram illustrating components of the payment processing system according to the present invention.

### DETAILED DESCRIPTION OF PREFERRED EMBODIMENTS

The figures are not intended to be exhaustive or to limit the present invention to the precise form disclosed. It should be understood that the invention can be practiced with modification and alteration, and that the disclosed technology be limited only by the claims and equivalents thereof.

The system disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

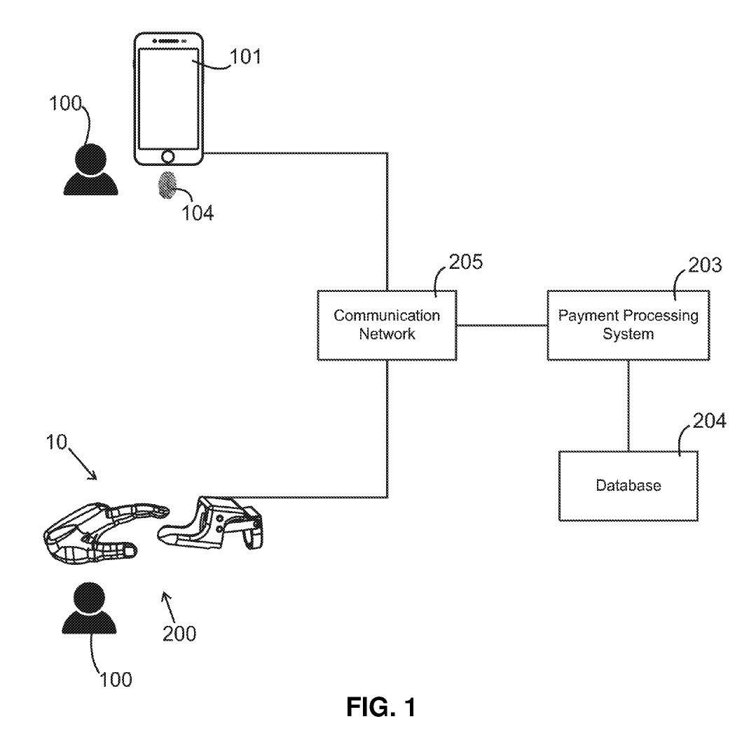

According to FIG. 1, a customer 100 installs the SnapPay application (payment application) on his/her mobile phone 101 to initiate registration of a biometric payment by fingerprint. Once registered they will now can upload his/her credit cards/debit cards/gift cards or bank accounts. After registration, the customer uses their mobile phone 101 to register their fingerprints 104 based on the guideline in the SnapPay application.

When the customer 100 approaches a point of sale (SnapPay terminal) 200 to make a purchase and pay for the purchased item via fingerprint; the customer uses the touchless fingerprint apparatus 10 of the present invention for the payment. After a fingerprint 104 of a customer 100 is captured, the merchant at the SnapPay terminal 200 uses communication network 205 for comparison the image of the fingerprint with previously registered fingerprint in a database 204 to confirm whether the attempting person is an authorized user. A confirmation will be sent to the payment processing system 203 which processes the transaction.

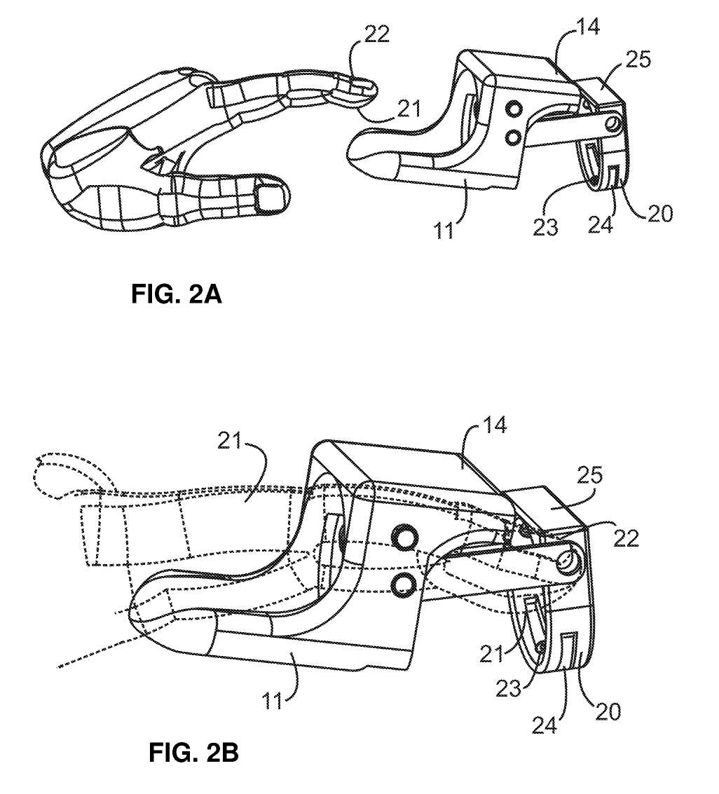

FIGS. 2A and 2B show a touchless fingerprint imaging apparatus 10 at the SnapPay terminal according to one embodiment of the present invention. The apparatus 10 comprises of a finger support 11, which has a height and a width. The distal end 14 of the finger support 11 includes a hollow ring shape finger receiving area 20 which is sized and shaped to receive at least a finger 21 of a user. The user inserts the finger 21 in a finger-receiving area 20 so that the top portion 22 of the finger 21 engages with the top portion 25 of finger receiving area 20. A fingerprint image capture device 23 is provided in the apparatus to capture the fingerprint image. The finger support and the camera are mounted at the SnapPay terminal so that the distal end of the finger of the user stands in a distance and without any movement above the fingerprint image capture device 23. The image capture device 23 is operable to acquire a fingerprint image of the finger in a touchless manner. The image capturing and retrieving may be automatically generated by the presence of finger 21 in finger receiving area 20.

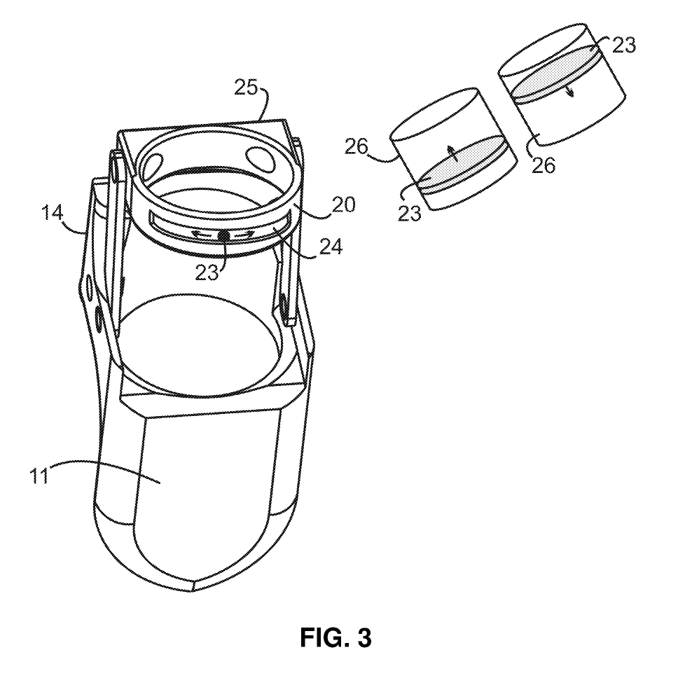

Again as shown in FIGS. 2A, 2B and 3, the fingerprint image capture device 23 is touchless, so that is positioned about a distance from the finger-receiving area 20 and the finger 21 does not touch image capture device 23 or other image capture surface during the fingerprint image capturing process. This distance depends on various characteristics of image capture device 23, such as focal length, resolution, light sensitivity, etc. The apparatus 10 can be used by people with no concentration, shaky hands due to various diseases for example low blood pressure, low sugar or Parkinson or even elderlies.

The fingerprint images are captured within touchless fingerprint imaging apparatus 10, in a temporary memory that resides within image capture device 10. The fixed position for fingerprint image capture apparatus 10 can be achieved in several different ways. In some embodiments, the camera 23 and the finger support 11 are fixedly and securely mounted on a stand beside the SnapPay terminal in a desired manner. In another embodiment, the finger support 11 is a freehold device which can be fixed in a desired distance of the POS. In another embodiment the finger support 11 is fixed in the POS area so that a moveable camera can move circularly in the finger-receiving area 20 in a circular path 24 to capture a 3D image. In such a way, the distance of the camera to the finger keeps the same by moving the camera in 2 dimensions within the circular path 24.

In one embodiment of the present invention, for capturing the 3D image of the fingerprint by the present arrangement; the circular path 24 can be semi-circular or any configuration to keep the finger in a same distance from the camera.

In another embodiment of the present invention, the image capture device (camera) 23 is adjustable inside the circular path 24 in such a way to keep the finger in a same distance from the camera 23. The image capture device (camera) 23 has a tubular canal 26 within the circular path 24 which can move up and down and change the focal distance prior to the finger of the user while is moving in the circular path 24. The image capture device 23 has three dimensional movements.

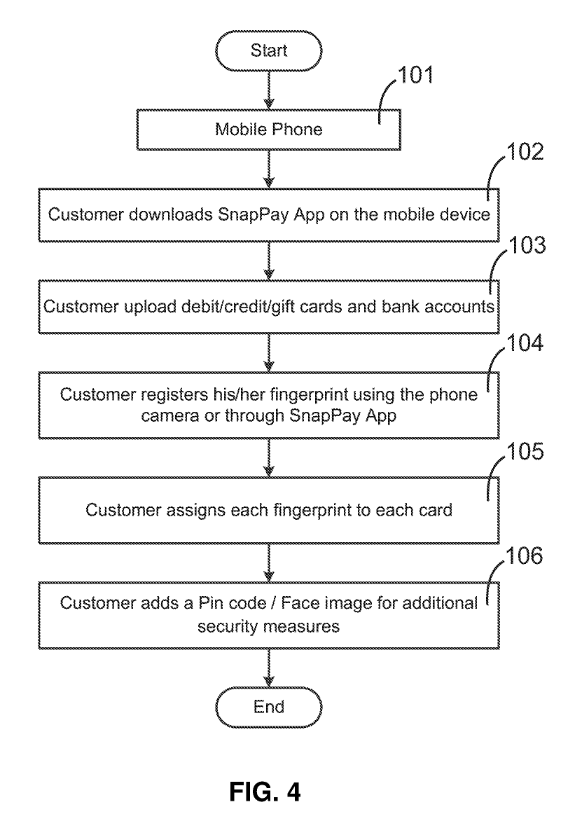

According to FIG. 4, in operation, a customer 100 need to install the SnapPay application (payment application) 102 on their mobile phone 101 to initiate registration of customers fingerprint. Once they download the application 102, they can register themselves by using their email address. Once registered they will now start uploading their Credit Cards/Debit Cards/Gift Cards or Bank accounts 103.

After registering themselves, customers will now use their mobile phone to register their fingerprints 104; it can be done by a camera on the mobile phone or through the application. The registration may be based on a variety of later-developed or current touch screen technology including resistive displays, capacitive displays, optical sensor displays, electromagnetic resonance, or the like. Once the registered fingerprint is saved in database, can be retrieved and used as valid payment device for payment of any transaction. Customers can now assign their fingerprints to each card 105. The SnapPay application enables a connection between the customers fingerprint characteristics with the financial account information of the customer. The information is saved in a database associated with the payment system. Additionally or alternatively, the customer can add a PIN code to each card and/or a picture of their face 106 and save it in the application for additional security measures. This system can be enhanced face/voice recognition/command.

After the registration process is completed, customer can go to any SnapPay terminal without carrying any payment device to make a payment. Furthermore, each fingerprint may correspond to special account of the customer, for example, the index finger may correspond to the debit card of the customer while the thumb may correspond to master card of the customer, or middle finger may correspond to visa card. They can use multiple fingerprints for multiple cards. A customer can store maximum 10 cards in the present platform.

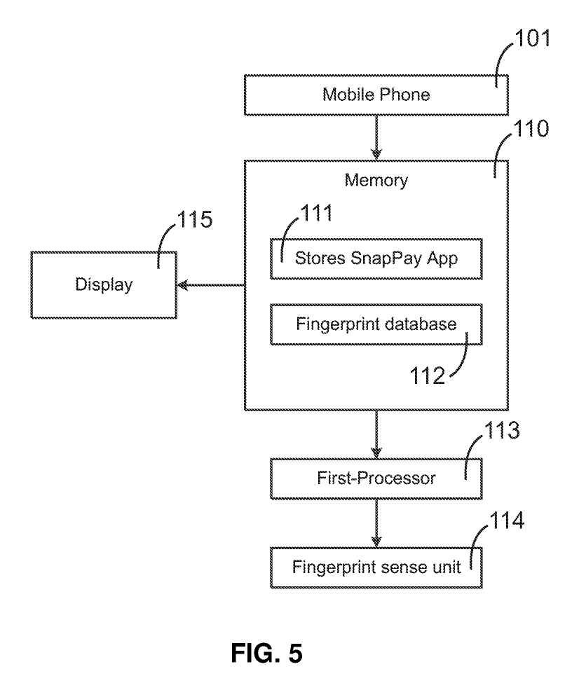

According to FIG. 5, the mobile device 101 comprises a memory unit 110 for storing the SnapPay application 111, a first-processor 113 which implements the SnapPay application, a fingerprint sensing unit 114 and a display unit 115. The memory unit 110 stores application software (SnapPay application) 111 and fingerprint databases 112 for recording fingerprint information of a user.

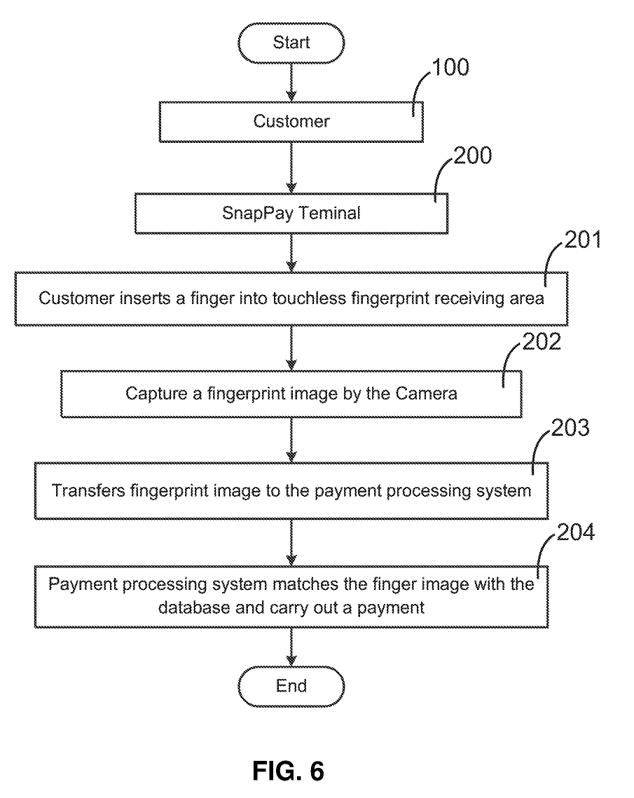

According to FIG. 6, a customer 100 approaches the SnapPay terminal 200 and inserts her/his finger into the finger receiving area 201 of the touchless fingerprint payment apparatus. The camera 202 captures an image of the fingerprint. Based on techniques disclosed in prior art; the SnapPay terminal camera, when capturing a fingerprint, determines sets of minutia and ridge points, such as ridge endings, directional information, and bifurcations of the ridge patterns extracted from the fingerprint, hereinafter referred to as minutiae set.

After the customer 100 scans the fingerprint the merchant accesses the information of the registration application associated with the customer 100 through the communication network. Through the registration application, the customer 100 submits financial account information.

The payment processing system 203 includes a comparator to allow comparison between digital signature stored at the time of registration and those received at the time of payment. Payment processing system 203 sends the image of the fingerprint to the database 204 for comparison with a previously registered fingerprint to confirm whether the attempting person is an authorized user. A fingerprint comparison will be made and if a successful match is obtained, the transaction will be processed. After the customer 100 enters relevant bank information, the package is sent to the payment processing system 203, which creates a payment method corresponding to the fingerprint, and saves the established association between the fingerprint and the customer's financial account into the database 204. At the end of the each process the customer receives a message and a receipt confirming a successful payment.

The SnapPay terminal encrypts the received captured image of the fingerprint and transmits the encrypted image via a communication network, to the payment processing system 203. In one embodiment, the payment processing system 203 then compares the image with registered fingerprint to determine whether or not the captured image corresponds to the registered fingerprint.

If the match operation as a result of the comparison yields a “Yes” the payment processing system 203 identifies the customer as a registered user. Then, the payment processing system 203 deconstructs or analyses the fingerprint image matching with the customers registered fingerprint to determine identifier information of the customer 100. The payment processing system 203 also identifies a financial account connected to the customer based on the account information of the customer 100.

In one embodiment after registration of the customer's fingerprint as a method of payment; the application can request the customer to enter a password tied to the fingerprint for additional security or verification. The unique code is entered at the time of registration of the fingerprint as a biometric payment instrument.

Once confirmed, the SnapPay terminal 200 initiates transfer of the payment amount from a payment account associated with the customer's fingerprint to a financial account associated with the SnapPay terminal, and generates message of successful transfer on both the mobile phone of the customer and the SnapPay terminal.

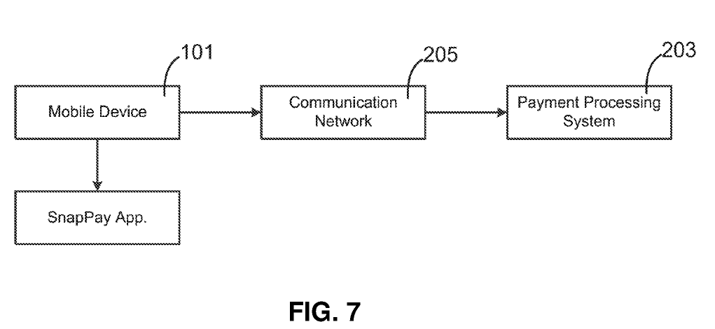

According to FIG. 7, the mobile device 101 and payment processing system 203 communicate with each other through a communication network 205 based on protocols and components for communicating over such network, which are well known in the art.

Payment processing system 203 will collect and store the payment transaction data that can include an amount of payment transaction, identification of the associated financial account and item-level. Item level is the information of items purchased or the service. The system will generate a digital receipt based on the transaction data and send it to the mobile phone 101 as a message or email.

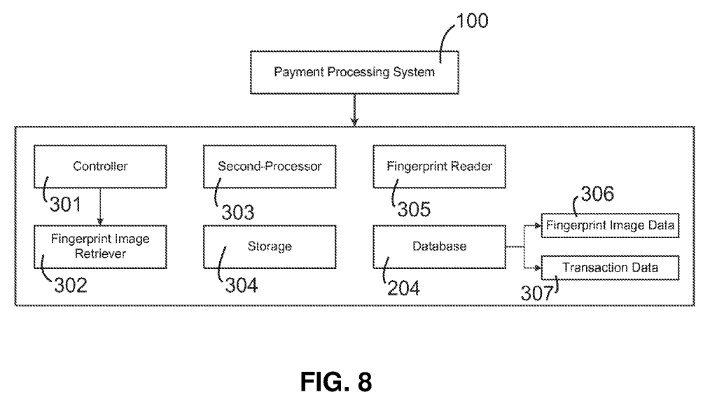

FIG. 8 is a block diagram illustrating embodiments of a payment processing system 203. The payment processing system 203 comprises of a controller 301 configured to allow processing of payment transactions between the customer and the SnapPay terminal. The controller 301 stores, identifies, generates, matches, and/or enables interactions with a computer through various technologies, and/or other related data. For example, the controller 301 on receiving payment related information may complete the transaction, generate receipt as proof of the transaction and the like. The controller 301 further comprises of a fingerprint image retriever 302 to compare the image of a customer's fingerprint captured by the SnapPay terminal camera and the registered fingerprint of the customer. The controller 301 further starts and stops the image capture process.

The system includes a second-processor 303 and a memory device 304 having a plurality of programs to receive the image captured from the SnapPay terminal camera 201 and compare it with the image of registered finger print of the customer and determine whether both of the images depict identical subjects. Images captured by image capture devices are stored in the memory 304.

The payment processing system 203 further comprises of a fingerprint reader 305 for acquiring biometric measurements of the fingerprint of the customer. For this purpose, the acquired fingerprint measurements may be compared with the registered fingerprint of the customer.

The payment processing system 203 further comprises a database 204 including fingerprint image data 306 and transaction data 307. The system includes encryption algorithms allowing for the secure transmission of information across a communications network. A fingerprint image data 307 includes fields such as, fingerprint image, fingerprint minutiae set, ridge count, and/or the like. The transaction data 308 includes fields such as, transaction information, purchases made, purchase history, price of the product, and/or the like.

After the payment is made customer will receive their receipts to their phone/email. They can also go online or on their application to access previous receipts and their usage. Customer will also receive a message every time they make a payment.

In another embodiment of the present invention, the payment processing system can be upgraded where the payment terminal performs a “touchless scan” of a finger instead of taking a picture. The touchless scanner can comprise of a deep depth of field lens, CCD linear image sensor and high directivity LED lamp to retrieve the fingerprint of the finger.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1. A touchless fingerprint apparatus comprising:
a) a finger-support to secure a finger in a distance above an image capturing device, wherein said finger-support having a finger-receiving area to keep said finger in said distance from said image capture device;
b) wherein said image capture device has a circular path which at least one camera lens is hovering around said finger to capture a 3D image; and
c) wherein said image capture device moves up and down within a tubular canal.

2. The touchless fingerprint apparatus of claim 1, wherein said distance depends on the characteristics of said image capture device, such as a focal length, a resolution and a light sensitivity.

3. The touchless fingerprint apparatus of claim 1, wherein said image capture device is touchless.

4. The touchless fingerprint apparatus of claim 1, wherein said circular path is a semi-circular path.

5. The touchless fingerprint apparatus of claim 1, wherein said image capture device has three dimensional movements.

6. A touchless biometric payment system comprising:
a) a touchless fingerprint apparatus to capture a fingerprint image comprises:
i) a finger-support to secure a finger in a distance above an image capturing device, wherein said finger-support having a finger-receiving area to keep said finger in said distance from said image capture device;
ii) wherein said image capture device has a circular path which at least one camera lens is hovering around said finger to capture a 3D image;
iii) wherein said image capture device moves up and down within a tubular canal;
b) a payment processing system to retrieve and compare said fingerprint image with a database; and
c) a computer-implemented program to manage and process the payment.

7. The touchless biometric payment system of claim 6, wherein said distance depends on the characteristics of said image capture device, such as a focal length, a resolution and a light sensitivity.

8. The touchless biometric payment system of claim 6, wherein said image capture device is touchless.

9. The touchless biometric payment system of claim 6, wherein said circular path is a semi-circular path.

10. The touchless biometric payment system of claim 6, wherein said image capture device has three dimensional movements.
